(19) United States
(12) Patent Application Publication
(10) Pub. No.: US 2009/0032612 A1
(43) Pub. Date: Feb. 5, 2009

(54) HIGH-FREQUENCY SPRAYING DEVICE

(76) Inventors: Jurgen Kunstmann, Bad Soden (DE); Jorg Rathenow, Wiesbaden (DE); Soheil Asgari, Wiesbaden (DE)

Correspondence Address: DORSEY & WHITNEY LLP;INTELLECTUAL PROPERTY DEPARTMENT, 250 PARK AVENUE, NEW YORK, NY, 10177, US

(21) Appl. No.: 10/585,568

(22) PCT Filed: Jan. 5, 2005
(86) PCT No.: PCT/EP2005/000041

§ 371 Date: Oct. 16, 2008

(30) Foreign Application Priority Data
Jan. 5, 2004 (DE) 10 2004 001 095.1

(51) Int. Cl. B05B 17/06

(52) U.S. Cl. 239/102.2; 118/50.1; 118/724; 118/729; 118/642

(57) ABSTRACT

A high-frequency spray device is provided that is suitable for applying a coating fluid onto a substrate. The spray device can include an atomizing arrangement, a movable substrate holder, a gas supply, and one or more temperature control elements. The atomizing arrangement can include a resonance body which may have a trumpet-like shape and which can be excited to produce high-frequency vibrations that may provide a spray mist jet of the coating fluid. The spray device can further include a field arrangement capable of generating an electric and/or magnetic field in the region containing the substrate which may influence the deposition of the spray mist jet on the substrate. The spray device may also include a suction arrangement that can affect the shape of the spray jet mist and/or withdraw a portion of the spray jet mist.

### CROSS REFERENCE TO RELATED APPLICATION(S)

This application is a national stage application of PCT Application No. PCT/EP2005/000041 which was filed on Jan. 5, 2005, and published on Jul. 21, 2005 as International Publication No. WO/2005/065843 (the “International Application”), the entire disclosure of which is incorporated herein by reference. This application claims priority from the International Application pursuant to 35 U.S.C. § 365. The present application also claims priority under 35 U.S.C. § 119 from German Patent Application DE 10 2004 001 095.1, filed on Jan. 5, 2004, the entire disclosure of which is incorporated herein by reference.

### FIELD OF THE INVENTION

The present invention relates to a high-frequency spraying apparatus that can be capable of atomizing a coating fluid, and which may be equipped with a drying assembly that can be configured to dry and/or cross-link the coating fluid after it is applied to a body to be coated. The spraying apparatus may also include a substrate support which can be capable of retaining the body to be coated in a position suitable for coating during the coating process. For example, the present invention also relates to a high-frequency atomizing apparatus which can atomize the coating fluid using a resonance body that can be excited to produce high frequency vibrations and thereby form a spray mist.

### BACKGROUND INFORMATION

High-frequency vibrations produced by excitation of a resonance body can be generated in an electromechanical converter using piezoceramic elements which have been excited to produce mechanical vibrations. These mechanical vibrations may, when amplified, be provided to the resonance body. A coating fluid film applied continuously to the resonance body can be excited by these mechanical high-frequency vibrations to form capillary waves. Fine droplets on vibration cavities which may form on the capillary wave can be cut off, which can result in the formation of an atomization or spray mist.

Applications for a pressureless high-frequency atomizing device may include, for example, air or product moistening, microelectronics, medical engineering, etc. Further, pressureless high-frequency atomizing devices may be suitable for gassing and/or degassing of fluids. High-frequency atomizing devices may also be suitable for use as separating devices and/or for the delivery of fluids in filling and mixing processes.

High-frequency atomizing devices may also be used in the field of medical engineering, for example, for coating of mechanical implants, bone and joint screws, heart valve prostheses and filigree substrates, vascular supports such as stents, etc., with a thin and homogeneous layer of a coating fluid. These stents may be required, for example, to permanently protect a coronary artery of a cardiac infarction patent, which was widened by means of a balloon dilation, from renewed occlusion. To protect the coronary artery, a stent which can assume, for example, the shape of a hollow cylindrical wire netting in the form of a lattice gate, comparable to a hair curler, can be fitted into the coronary vessel. In this manner, renewed occlusion of the vessel can be prevented or at least temporary postponement thereof may be allowed in many cases.

These stents, together with other medical implants or other bodies to be coated, can be referred to collectively as substrates. To ensure that the substrate is not rejected by a human organism, such substrate may be provided with a suitable coating that is not rejected by the human or animal body. To coat these substrates, which can be fine and/or filigree in nature, a high-frequency atomizing device may be used.

An atomizing device which may be suitable for atomizing a coating fluid without using force or air induction is described, for example, in U.S. Pat. No. 4,655,393. The ultrasonic atomizer described therein includes two tubes connected to each other by a flanged connection oriented in a longitudinal direction. A drive element is inserted between the adjacent flanges of both tubes, which can excite an atomizing arrangement to generate ultrasonic vibrations. A feed hose is connected to a back portion of the ultrasonic atomizing arrangement that is capable of feeding coating fluid to the atomizing arrangement. The tubes on the front of the atomizing arrangement are reduced in diameter to allow a further solid tube section having a smaller diameter to be formed. The cross-section of this further tube section widens towards the front of the atomizing device, viewed along a circular trajectory, and terminates in a flat atomizer tip.

The flat atomizer tip and the inner cavity of the front tubes of the atomizing device described in U.S. Pat. No. 4,655,393 are connected by a plurality of thin rectilinear capillary tubes configured to load the atomizer tip with a coating fluid that may be excited to generate high-frequency vibrations. However, these fine tubes terminate obtusely and discontinuously in the flat tip of the atomizing device. This discontinuous transition between the tubes and the flat tip can result in an irregular spray pattern during operation of the atomizing device, and an irregular droplet size in the spray mist produced. For example, drops of larger diameter may also be formed because of this discontinuous transition, where the larger drops may accumulate initially on a tip of the atomizing device and then detach from the atomizer tip in response to gravity forces when they reach a certain size. For at least this reason, the atomizing device described in U.S. Pat. No. 4,655,393 may prevent formation of larger drops when used in a vertical alignment with an upward pointing spray tip or in a horizontal alignment. However, if a substrate to be coated is provided beneath this atomizing device, or if very thin, uniform coatings are being applied, larger drops may become detached from the spray tip and drip onto the substrate, which may render it useless or impair its performance.

Another problem which may be associated with the coating of substrates relates to a substrate holder which can retain such substrates are normally while being coated initially in a first stage using a spraying device. It may be necessary to remove the substrate from this substrate holder so that it can then be inserted, for example, into a drying oven for drying and/or hardening. Removal of the substrate from the substrate holder can be problematic if freshly applied coating film can be damaged easily, as such damage may occur upon removing the substrate from the holder which can render the substrate unusable for an intended application.

A further problem that may be encountered when coating substrates using a conventional high-frequency atomizing device such as that described, e.g., in U.S. Pat. No. 4,655,393, relates to the observation that the spray mist produced by such an atomizing device may only be capable of being modulated by the coating fluid supplied per unit of time at the excitation frequency. It may not be possible to influence the spraying characteristic further, e.g., to widen or narrow the spray jet or to accelerate the spray mist by guiding it in a particular direction.

Thus, there may be a need to provide an improved high-frequency atomizing device capable of coating filigree substrates, which generally does not suffer from the disadvantage of the formation of larger drops, and which can be operated with a downward-directed resonance body. Further, there may be a need to provide an improved high-frequency atomizing device that can provide coatings that are not likely to be damaged when coated substrates are removed from the substrate holder, for example, to insert them in a drying oven for hardening. There may also be a need to provide, for example, a high-frequency atomizing device that can influence the spray jet characteristics, not only by varying a coating fluid flow rate and an atomizer frequency, but also by accelerating the spray jet and/or allowing the spray cone to be widened or narrowed.

### OBJECTS AND SUMMARY OF EXEMPLARY EMBODIMENTS OF THE INVENTION

It is one of the objects of the present invention to provide a high-frequency atomizing device capable of coating a substrate, which includes an atomizing arrangement that can be excited to produce high-frequency vibrations, and which can atomize the coating fluid fed to it to form a spray mist. The exemplary atomizing arrangement can include a resonance body having a trumpet-like shape. The atomizing arrangement can be enclosed in a housing having an opening, and the resonance body can be positioned proximate to the opening. The housing may further be provided with a flow of air or inert gas from a gas supply. The housing can also include a nozzle associated with the opening through which the supplied flow of air or gas may escape.

The atomizing device may also be provided with a positionable substrate holder which is capable of retaining the substrate to be coated in a position favorable for coating inside the spray mist produced by the high frequency atomizing device throughout the atomizing and coating process, which may allow the substrate to be wetted uniformly with the spray mist produced, and further allow thin, homogeneous coats to be applied.

According to one exemplary embodiment of the present invention, the entire atomizing arrangement can also be moved along a substrate, or alternatively, a movably arranged substrate can be provided with a movably arranged exemplary atomizing arrangement.

According to another exemplary embodiment of the present invention, the high-frequency atomizing device may also include a heat source which can be suitable for drying the spray mist coat formed on the substrate without requiring removal of the substrate from the substrate holder. Thus, it would not be necessary to remove a freshly-coated substrate from the substrate holder for drying, thereby reducing the likelihood of damaging the freshly-coated substrate or a freshly-applied coating film.

According to a further exemplary embodiment of the present invention, the high-frequency atomizing device may also include one or more temperature setting arrangements, which can be provided to heat or cool certain elements or areas associated with the atomizing device. Certain elements that can be heated or cooled by these arrangements can include, e.g., a tank that may be used to hold the coating fluid, tubes or pipes that can transport the coating fluid between various components of the atomizing device, a pump that may be used to pump the coating fluid, and/or supply tubes that convey air or inert gas.

These and other objects, features and advantages of the present invention will become apparent upon reading the following detailed description of embodiments of the invention, when taken in conjunction with the appended claims.

### BRIEF DESCRIPTION OF THE DRAWINGS

Further objects, features and advantages of the invention will become apparent from the following detailed description taken in conjunction with the accompanying figures showing illustrative embodiments of the invention, in which:

FIG. 1 is a schematic illustration of a high-frequency atomizing device in accordance with certain exemplary embodiments of the present invention;

FIG. 2 is a cross-section illustration through a resonance body of the atomizing device in accordance with certain exemplary embodiments of the present invention; and

FIG. 3 is a schematic illustration of the high-frequency atomizing device according to another exemplary embodiment of the present invention which includes temperature setting arrangements and arrangements capable of generating electrical and/or magnetic fields.

### DETAILED DESCRIPTION OF EXEMPLARY EMBODIMENTS OF INVENTION

In the figures, similar elements are identified with corresponding reference symbols.

According to an exemplary embodiment of the present invention, an atomizing arrangement can be provided which includes an ultrasonic atomizer that may be suitable for atomizing a coating fluid fed to the atomizing arrangement into a fine spray mist. The exemplary ultrasonic atomizer can produce high-frequency ultrasonic waves that may include, for example, a piezoceramic element which can convert electric signals into mechanical waves. Thus a coating fluid provided without pressure to the ultrasonic atomizer can form capillary waves, and fine droplets may be detached from vibration cavities associated with these capillary waves. The exemplary atomizing arrangement can be provided with a resonance body which widens into a trumpet-like shape that is capable of feeding the coating fluid uniformly and continuously to the atomizer tip of the atomizing arrangement, from which the coating fluid is sprayed. This capillary-type resonance body that widens into a trumpet-like shape can vibrate together with the ultrasonic atomizer at an excited frequency. In this manner, the coating fluid fed to the resonance body can also vibrate in the excited frequency over the surface of the resonance body and form the capillary waves described herein above.

To supply the resonance body uniformly and continuously with coating fluid, the resonance body can be connected to a capillary tube that is configured to provide the inner face of the resonance body with coating fluid. To ensure that there are no discontinuities that may allow escape of the coating fluid from the capillary tube as it is provided to the inner face of the resonance body, the capillary tube can be incorporated in a nozzle of the resonance body so that the end of the capillary tube passes into the resonance body without any jumps or steps. The coating fluid that escapes from the capillary tube may therefore be distributed on an inner face of the resonance body in a thin film, where the inner face may widen concentrically to form a trumpet-like shape.

According to a further exemplary embodiment of the present invention, the resonance body may be provided in the shape of a horn that widens as viewed in cross-section, for example, in a form of a tractrix finction, an exponential finction or a clotoid function, or other similar forms. To increase the atomizing area of the resonance body, a funnel-shaped section, for example, can be connected to the horn of the resonance body described herein above. The horn of the resonance body may also be widened to such an extent that the radius of curvature of the horn is parallel to the capillary tube incorporated in the resonance body. In this exemplary configuration, the horn can be extended outward at its outer opening, for example, as a perforated disc including a single hole that may coincide with the horn opening. This enlargement of the resonance body can permit the entire quantity of coating fluid fed to the resonance body via the capillary tube to be atomized. This enlargement of the resonance body can further prevent non-atomized residues of the coating fluid from accumulating on the resonance body, where such residues can otherwise drop onto an edge of the resonance body in response to gravity without being atomized.

To avoid the detachment of large coating fluid drops on the resonance body, and/or to prevent variations in the coat thickness of the coating fluid film formed on the inner face of the horn, the resonance body which passes into a circular perforated disc, as described above, can be loaded with coating fluid using, e.g., a controllable, pulsation-free proportioning pump. Proportioning quantities between about 0.1 to 100 ml/min, or about 0.5 ml/min., can be used with, e.g., the conventional high-frequency atomizing device described above in connection with medical engineering applications. The exemplary high-frequency atomizing device in accordance with exemplary embodiments of the present invention may be operated with other proportioning quantities including, e.g., volumetric flows of up to about 50 l per, or smaller volumetric flows on the order of about 1 μl/min.

In accordance with the exemplary embodiments of the present invention, the individual dimensions of the device can be matched to each other, taking into consideration the volumetric flow and viscosity of the coating fluid, to obtain an improved spray pattern while avoiding detachment of undesirable drops. For conventional applications in the medical field, the inside diameter of the capillary tube can be selected to be between about 0.01 and 15 mm. For conventional coating fluids suitable for coating medical substrates, the diameter of the capillary tube can be chosen to be between about 0.3. mm and 0.5 mm, or approximately 0.4 mm. The diameter of the expanding resonance body can be matched to this tube, and a diameter of between about 3 and 30 mm can be selected as the diameter of the perforated disc described herein above. In medical engineering applications, the diameter of the perforated disc can be selected to be between about 3 and 30 mm, or approximately 8 mm.

To select a spray pattern of the exemplary high-frequency atomizing device, the spray mist can be modulated using a controllable air or inert gas jet, where the gas jet can also provide an explosion protection for the exemplary device. The air or inert gas jet can be produced by enclosing the entire exemplary atomizing arrangement, including the ultrasonic atomizer, within a housing that is open on one side, where the housing may be provided with a connection for a controllable inert gas supply and a connection for the coating fluid. In this manner, inert gas supplied to the inside of the housing via the inert gas connection can be focused and escape from an opening of the housing in the form of a jet. This inert gas jet can be used to modulate the spray pattern.

By arranging the resonance body of the ultrasonic atomizer, e.g., either directly within one opening of the housing or close to the housing opening, the spray pattern of the high-frequency atomizing device can be modulated by the inert gas jet. The volumetric flow of the spray mist can, for example, be accelerated by controlling the inert gas supply. The spray jet can also be directed and stabilized by the inert gas jet, which can enable a widening of the spray cone to be adjusted. Because of support provided by the inert gas, the spreading angle of the spray cone of the atomized coating material can be varied from about 0° to 180°, and spray jet cones having a spreading angle of approximately 30° may be used to coat smaller components such as, for example, substrates used in the field of medical engineering.

Characteristics of the spray jet can be influenced more effectively, for example, by providing one of the openings of the housing with an inert gas nozzle through which inert gas supplied by an inert gas feed can escape as a carrier medium to condition the spray mist. This nozzle may, for example, be provided as an expanding funnel which can expand or reduce in an outward direction from the housing opening. An annular gap can be formed between the funnel and the resonance body by providing the resonance body of the ultrasonic atomizer within the expanding or reducing funnel, and the inert gas fed to the inside of the housing can be able to escape through this gap. The width of the annular gap may, for example, be varied by moving the resonance body along a longitudinal direction with respect to the funnel, and/or by varying the angle of expansion of the funnel, which can allow the spray jet characteristics to be further influenced.

In contrast to conventional pressurized spray nozzles, the characteristics of the spray jet generated using a spray device in accordance with the exemplary embodiments of the present invention may be influenced in particular ways. For example, the spray jet may be varied not only by varying the volumetric flow of the coating fluid, but also by adjusting a working frequency of the atomizing arrangement in the ultrasonic range, e.g., between about 20 kHz and 3 MHz, preferably about 20 to 200 kHz. The spray jet characteristics may also be varied, for example, by varying the energy provided to the atomizing arrangement, which can range from between about 0.01 W and 100 W. The spray jet can be further varied, as described above, by adjusting the inert gas supplied to the housing in which the atomizing arrangement is provided. Another way to vary the spray jet characteristics can be to vary the annular gap formed between the resonance body and the expanding funnel in a connection to one of the housing openings.

Other conventional techniques that may be known in paint spraying technology can be used in various combinations with the techniques described above to modify the spray characteristics and pattern including, e.g., dilution of the liquid coating, selection of solvents to be mixed with the liquid coating, removal of the nozzle from the substrate, or mixing of additives with the liquid coating.

Extensive coatings can also be provided, e.g., by using a plurality of nozzles that may be arranged next to each other in a cascade configuration. An extensive or otherwise elongated substrate can be guided past the nozzles using, e.g., a conveyor belt, or alternatively the nozzles can be guided along a stationary substrate.

In further exemplary embodiments of the present invention, the exemplary high-frequency atomizing device can be provided with one or more arrangements that can allow adjustment of the temperature of the inert gas, the coating fluid and/or the coating chamber. For example, a controlled or uncontrolled arrangement may be provided for tempering inert air or gas in the device, which can, e.g., cool or heat the ultrasonic nozzle, the inert gas or the coating solutions, or any combination thereof, by a heat exchange mechanism.

Constant and/or homogeneous conditions can be provided for the coating medium, the coating fluid, and/or a dispersion which may be formed in different aggregate conditions throughout the spray coating procedure. For example, the temperature of the coating fluid may not change substantially over a path from a storage tank to the atomizing arrangement. Constant conditions, e.g., temperature conditions, can be disturbed, for example, if the spray head or the atomizing arrangement is heated in response to energy supplied when an ultrasonic spray head is used. This heating could be transmitted to the coating fluid to be applied and result in the heating of the fluid. For example, if the exemplary atomizing arrangement is heated, the temperature can rise to the melting point of particles which may be present in the coating fluid. This heating can result in melting of the particles, which in turn could stick to the exemplary atomizing arrangement or the ultrasonic spray head, leading to poor quality of the spray application and/or resulting coating.

The heating procedure can also lead to a premature evaporation of a solvent that may be present in a coating fluid, where evaporation can occur before application of the coating liquid to a substrate. This premature evaporation, unless provided intentionally, may also result in poor quality of the spray application and/or resulting coating.

It may therefore be advantageous to provide an approximately constant temperature throughout a path or process for distributing of a gas or a coating fluid. This approximately constant temperature may be provided, for example, by cooling of an overheated area, e.g. an overheated atomizing nozzle, using a temperature setting device or, for example, by heating a supply line system, an air or gas supply, tubes, including capillary tubes, or another distribution arrangement for the coating fluid or for particles dissolved in a solvent. This heating may be preferred if, e.g., the distribution system passes through a colder area of the device which may lead to cooling of a portion of the distribution system. If such cooling occurs, for example, the conveyed coating fluid could also be cooled. The fluid, which can be liquid under normal operating conditions, could become more viscous when cooled and obstruct or impair transfer of the fluid. Heating of the distribution system may also indirectly heat the conveyed medium and/or coating fluid, thereby influencing the temperature of the coating fluid.

A procedure to directly influence the temperature of the coating fluid can also be performed. For example, a heating coil or a heat exchanger may be provided in or on the distribution system or it may be flushed by the coating fluid, thereby also regulating the temperature, for example, by a control or regulating system that is capable of either supplying or discharging heat. Heat may also be supplied using, e.g., infrared or inductive arrangements.

In certain exemplary embodiments of the present invention, different temperatures can be provided at different regions of the distribution system. Although a low a temperature gradient may be preferable in certain configurations, as described above, a temperature gradient may be desired in certain procedures. For example, temperature variations may be desired when applying certain coatings such as, e.g., coating fluids or dispersions containing particles which can be efficiently transferred in conjunction with a solvent.

In further exemplary embodiments of the present invention, particles in a coating material may be present in an undissolved form, which can require removal of a solvent. An increased temperature provided in a region or portion of the exemplary atomizing arrangement, e.g., in a resonance body or a tube, can allow a solvent to vaporize or evaporate so that the particles can be present in an undissolved form on the spray head or atomizing arrangement or on the sound head. The coating fluid can be conveyed from a storage container to an atomizing assembly at temperatures which can maintain particles dissolved in the solvent to facilitate transfer of the fluid. An increased temperature provided at the atomizing arrangement can allow the solvent to vaporize in the region of the atomizing arrangement or the ultrasonic atomizer, so that the particles transferred to the ultrasonic atomizer or sound head may be present in undissolved form, and therefore may be applied more efficiently.

Other temperature gradients may be used for particular applications, coating fluids and/or dispersions. For example, these temperature gradients may be providing using, e.g., temperature setting arrangements or process temperature control devices, which may control predetermined conditions for a particular coating process.

The temperature and/or coating characteristics of the coating fluid, the spreading capacity of a coating fluid, and/or droplets or particles formed by a coating fluid, can be influenced by varying the temperature of an inert gas added in an air flow. This variation in temperature may be achieved directly or indirectly.

A region or area around the substrate or, if desired, the coating chamber, can be tempered completely or partially. To achieve this, a hot spray mist formed from, e.g., atomized hot particles, can be mixed with a cooled inert gas or distributed in a cooled coating chamber, so that it cools, thereby improving the adhesion of the particles to a substrate. This can affect the temperature of the inert air or the inert gas, e.g., a mixture of coating fluid with inert gas or air.

Increasingly precise temperature gradients can be provided, and more flexible conditions can be used in a coating process, by distributing more temperature setting arrangements within and over the distribution system for the coating fluid, inert gas and/or air, and/or in the coating chamber. Settings for the various temperature setting arrangements may be linked to a microprocessor, thus allowing coordination of the control of these arrangements in a coating procedure.

Various components which may contribute to varying characteristics of a spray jet, such as those descried herein above, may be controlled by, e.g., a microprocessor to generate a spray pattern that may be preferable for a particular procedure. For example, the volumetric flow of the coating fluid provided by a proportioning pump, a working frequency and/or energy supplied to the ultrasonic atomizer can be controlled with a microprocessor. The microprocessor may also be used to control a flow of an inert gas supplied to the spray jet conditioning system. The individual factors which may influence the spray pattern can be set or controlled by the microprocessor, and these factors may be interdependent.

Characteristics of a coating applied to a substrate can be improved using an ultrasonic atomizer in accordance with the exemplary embodiments of the present invention, as described herein above. The coating quality can be improved further by, for example, retaining the substrate to be coated inside the spray mist during the coating process in a position that is favorable for coating using a substrate holder. The substrate holder can be configured to provide, e.g., three translational and three rotational degrees of freedom of movement of the substrate, in the region of the spray mist produced. For example, the substrate can be moved in the region of the spray mist in three different coordinate directions, using the substrate holder, which may allow the substrate to be coated uniformly with a coating fluid.

According to yet a further exemplary embodiment of the present invention, a coating applied to a substrate using the high-frequency atomizing device described herein can be further improved if, e.g., the substrate does not need to be removed from the substrate holder following the coating process for drying purposes, for example, so that it can be hardened in a drying oven. This can be achieved, for example, by providing a high-frequency atomizing device which includes a drying arrangement that can be suitable for drying, hardening or cross-linking the spray mist coat formed on the substrate. For example, it can be possible to dry or cure an applied coating film using the drying arrangement during the coating process, while the coating film is being applied.

Drying of the coating film can be achieved, for example, by heating a freshly-coated substrate using a heat source during the coating process. A heat source may include, for example, a heating system which may be enclosed by a heating housing that can be open on one side, and which includes a controllable inert gas supply for generating a flow of hot air or gas. The inert gas fed to the heating housing can be heated in the heating housing and escape from it through a nozzle arranged on an opening of the heating housing, and the heated gas can be directed towards the substrate using the nozzle.

The coating film can also be dried, e.g., by first applying a full coating onto the substrate, and then moving the fully-coated substrate, together with the substrate holder, proximate to the escape opening of the heating housing nozzle, so that drying and/or hardening of the coating film can be achieved after the coating process.

In addition to drying the applied coating using thermal convection, the coating film formed on the substrate may also be dried indirectly by radiation, including infrared radiation. The use of thermal radiation can provide a heat source for generating the thermal radiation to be located outside the area of the high-frequency atomizing device, which can reduce a risk of explosion. For example, the heat source for generating the thermal radiation may be arranged outside of a housing which may enclose the exemplary atomizing arrangement and the positionable substrate holder. This configuration can prevent or reduce cross flows of gases that may have a detrimental effect on a homogeneous spray pattern. The housing can therefore protect the spray pattern generated by the exemplary atomizing arrangement before any cross flow of gases can exert a possible negative influence such as, e.g., disrupting or distorting the spray pattern, so that the coating result and its quality can be improved further.

In a further exemplary embodiment of the present invention, a suction device can be provided which is capable of collecting and drawing off the overspray, e.g., the quantity of atomized coating fluid which may be sprayed past the substrate to be coated. The suction device can be provided within the housing, for example, so that the overspray is not lost and allowing it to be fed back to the atomizing arrangement, for example, to be atomized again. The suction device, as well as the substrate holder, can be controlled by the microprocessor described herein above, so that the spray characteristic of the atomizing device can also be influenced, for example, by manipulation of the suction flow, e.g., by generating a vacuum. Further, controlling the substrate holder using a microprocessor can allow the substrate to be coated to be maintained in an optimal or preferred position in the region of the spray jet produced, where this position may further depend on other process parameters.

Freeze drying, vacuum drying and/or flow drying in the air or gas flow, using suitable drying arrangements, may be used to dry or cure the applied coating. A suitable drying technique and an arrangement that is capable of performing it can be selected and provided for each desired coating and drying task.

Drying, hardening and/or cross-linking may involve the transition of the coating fluid from the liquid to the solid state. The treatment of an applied coating selected for a specific coating procedure can depend, e.g., on the coating material used and other process parameters.

For example, emulsions, suspensions and/or solutions of solid or liquid substances in suitable solvents may be used as coating fluids. Solutions, suspensions, dispersions or emulsions of one or more active substances or active substance precursors provided in a suitable solvent may be atomized, and undiluted liquid active substances may also be atomized. Further, solutions, emulsions and/or suspensions or dispersions of one or more polymeric or non-polymeric organic or inorganic substances, or any mixtures thereof, optionally together with cross-linking agents, as well as reacting multicomponent compounds, can also be atomized. Reacting multicomponent compounds may use a suitable drying and/or setting mechanism or an adequate pot life, to avoid reaction and setting of the compounds inside the exemplary atomizing device. Coating materials provided, e.g., in solutions, dispersions, suspensions or emulsions, may contain particles that can include polymeric, non-polymeric, organic or inorganic or mixed inorganic-organic or composite particles, or any mixtures thereof. Microparticles and nanoparticles may also be used. Examples of polymeric particles include, e.g., PMMA, PLA, proteins, etc. Examples of non-polymeric particles can include, but are not limited to metals, metal oxides, metal carbides, metal nitrides, metal oxynitrides, metal carbonitrides, metal oxycarbides, metal oxynitrides, metal oxycarbonitrides, metal hydrides, metal alkoxides, metal halogens, inorganic or organic metal salts. Magnetic particles that may also be used include, but are not limited to, iron, cobalt, nickel, manganese or mixtures thereof, for example, iron-platinum mixtures, or magnetic metal oxides, iron oxide or ferrites. Non-polymeric particles that may be used include, e.g., soot species and other nanomorphic carbon species, such as graphite, diamond, nanotubes, fullerenes and the like. Particles which are provided from sols and gels may also be used.

Melts of thermoplastic coating substances, e.g., tar, may also be used. Other coating substances that may be used can be based on dyes and varnishes, organic polymers, duro- and thermoplastics, and may further contain fiber constituents such as cellulose, glass, stone or carbon fibers, and polymer fibers with organic and inorganic additives, or catalysts. Other suitable coating substances are described, e.g., in German Patent Application DE 103 24 415.

The term “active substances” can refer to pharmacologically active substances such as drugs, medicinal products or pharmaceutical products, as well as microorganisms, living organic cell material, enzymes and biocompatible inorganic or organic substances. The term “active substance precursor” can refer to a substance or a mixture of substances which can be converted to active substances such as those described above being applied onto an implant to be coated using thermal, mechanical, chemical or biological procedures.

Molten active substances, or active substances dissolved, suspended or dispersed in melts, may also be applied by the exemplary atomizing device described herein, as well as active substances which can be suspended, dispersed or emulsified such as, for example, active substances encapsulated in polymers. In another exemplary embodiment of the present invention, the distribution of the coating solution or of components of the coating solution, and/or the geometrical orientation, e.g. of particles with magnetic properties or conductive properties, can be influenced by using an anode and pole plate arrangement that is based on magnetic and/or dielectric principles of action, where the anode and pole plate arrangement may be provided with one or more channels and a spatial alignment that can be varied.

An electrode or electrostatic arrangement, which may include activation electronics and an energy source, can be provided as an integral part of the exemplary atomizing device, and configured so that it can influence the distribution, charging, alignment and/or morphology of coating solutions and/or their constituents using variable magnetic and/or ionization fields.

Particles, including movable or flying particles or droplets, can be influenced by the crossing of electrical or magnetic fields. In exemplary embodiments of the present invention, particles can be used that may be electrically charged or ionized as they cross electrical or magnetic fields provided for this purpose, or which may otherwise be influenced by an interaction with such fields. For example, a mutual alignment of particles may be varied. A variation of alignment can be produced, e.g., by a magnetic field, particularly if the particles used contain ferrite.

Ionization, electrical charging or variation in the mutual alignment of particles being applied can generate an extremely uniform distribution of a coating film or a coating fluid. Particles orientated in such a manner, including nanoparticles, may have better adhesion to a substrate. Moreover, a subsequent or simultaneous drying procedure can be accelerated and improved by a uniform particle alignment and associated morphology.

Coating fluids, including spray mists or droplets formed therefrom, can thus be influenced by electrical and/or magnetic fields. Fields that may be used can include, e.g., electro- or magnetostatic fields, or time-varying fields that can be modulated by frequency patterns. The influence of electrical or magnetic fields may occur during flight of the particles or the spray mist being applied, or it may occur during or after deposition of the coating on the substrate. The influence of the electrical or magnetic fields may take place simultaneously or it can be staggered in time. Further, a multi-channel influence, e.g., an influence generated by a plurality of arrangements provided to generate electrical and/or magnetic fields, which can also act in different spatial planes, can also be used.

Electrical fields can be generated by means of electrode, anode and/or pole plate arrangements suitably configured in the atomizing device described herein. These arrangements may, if necessary, be supplied with high voltage (HV). The geometry of the fields and their intensity may be influenced by the shape of the electrodes.

Magnetic fields may, for example, be generated by means of electromagnets or permanent magnets suitably arranged in the atomizing device described herein. The intensity and geometry of the magnetic fields may be influenced by the shape of the magnets used.

As an alternative to generating electrostatic or magnetostatic fields, electric and/or magnetic fields can be activated and/or modulated with certain frequency patterns and/or by a time-varying intensity, which can influence wetting behavior of the coating fluid and the way in which the spray mist is deposited on the substrate.

A continuous or time-varying magnetic field can be generated, e.g., using a magnet, which may be an electromagnet that can be modulated in frequency and/or amplitude using microprocessor control. The magnet can be provided with pole shoes arranged in a suitable geometric configuration. An arrangement that includes the magnet can also be moved spatially in relation to the substrate to be coated, e.g., using a microprocessor to control the movement. An exemplary arrangement provided for generating a modulated low-frequency/high-frequency field can include, e.g., a microprocessor control arrangement for generating frequency and amplitude samples, and two or more electrodes, which may be aligned axially or radially and which may be moveable, according to the specific coating application.

Solvents that may be suitable for use in coating fluids provided in the form of solutions, suspensions or emulsions, can include, for example, alcohols, ethers and/or hydrocarbons such as, e.g., methanol, ethanol, n-propanol, isopropanol, butoxydiglycol, butoxyethanol, butoxyisopropanol, butyoxypropanol, n-butyl-alcohol, t-butyl-alcohol, butylenes glycol, butyl octanol, diethylene glycol, dimethoxydiglycol, dimethyl ether, dipropylene glycol, ethoxydiglycol, ethoxyethanol, ethylhexane diol, glycol, hexane diol, 1,2,6-hexane triol, hexyl alcohol, hexylene glycol, isobutoxypropanol, isopentyl diol, 3-methoxybutanol, methoxydiglycol, methoxyethanol, methoxyisopropanol, methoxymethyl butanol, methoxy PEG-10, methylal, methyl-hexyl ether, methylpropane diol, neopentyl glycol, PEG-4, PEG-6, PEG-7, PEG-7, PEG-9, PEG-6-methylether, pentylene glycol, PPG-7, PPG-2-buteth-3, PPG-2 butyl ether, PPG-3 butyl ether, PPG-2 methyl ether, PPG-3 methyl ether, PPG-2 propyl ether, propane diol, propylene glycol, propylene glycol-butyl ether, propylene glycol-propyl ether, tetrahydrofuran, trimethylhexanol, phenol, benzol, toluene, xylol; and/or water, optionally provided in a mixture with dispersion aids, as well as any mixtures or combinations of the above.

In certain exemplary embodiments of the present invention, the surface of the substrate to be coated can be partially or essentially completely coated, or it may be coated with multiple layers. Multiple coatings can be provided by using the atomizing device described herein in separate consecutive procedures and, if necessary, drying steps may be applied after individual coating procedures.

For example, complete closed coatings having a thickness of approximately 1 nm to approximately 1 mm, or thicker, can be produced using the spray device according to exemplary embodiments of the present invention. The exemplary coatings can be produced having a thickness between about 1 nm and 100 μm, or from about 1 nm to 10 μm, or between about. 1 nm and 1 μm. The exemplary coatings can also be produced which have a thickness between about 10 nm and 1 μm, or between about 1 nm and 10 nm.

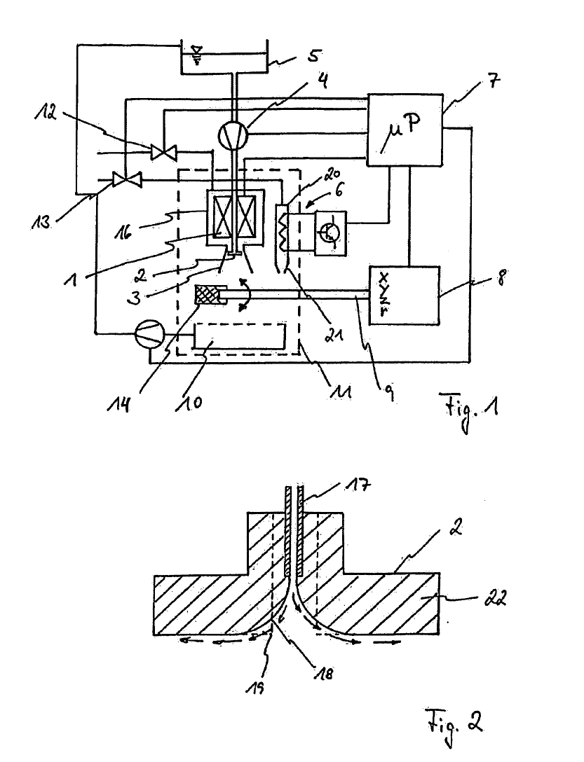

FIG. 1 shows a schematic illustration of an exemplary embodiment of a high-frequency atomizing device in accordance with the present invention. The exemplary high-frequency atomizing device can include an atomizing arrangement 1, which may be suitable for atomizing a coating fluid fed to it. The atomizing arrangement 1 may, for example, be an ultrasonic atomizer which can be excited, for example, by a piezoelectric element to generate high-frequency vibrations. A coating fluid, which may be stored in a storage tank 5, can be provided to the atomizing arrangement 1 by a precision proportioning pump 4. The coating fluid can be pumped from the storage tank 5 by the precision pump 4 via a system of tubes to the exemplary atomizing arrangement 1. The coating fluid that is fed in this manner to the exemplary atomizing arrangement 1 can be excited by the exemplary atomizing arrangement 1 to generate high-frequency vibrations, and can be conveyed further in the direction of a resonance body 2 by a continuous volumetric flow generated by the precision proportioning pump 4 via a capillary tube 17. The coating fluid can be excited directly by using the atomizing arrangement 1 to generate vibrations as the fluid passes through it. Alternatively, the resonance body 2 can be excited, which in turn can excite the coating fluid to produce vibrations therein as the fluid reaches the resonance body 2.

A cross-sectional enlarged illustration of the exemplary resonance body 2, together with the exemplary capillary tube 17, is shown in FIG. 2. The capillary tube 17 can be incorporated into the resonance body 2, such that no discontinuities or jumps are present in the transition between the end of the capillary tube 17 and an expanding inner face 18 of the resonance body 2. The coating material which may be excited to generate high-frequency vibrations by the exemplary atomizing arrangement 1 can be fed by the capillary tube 17 to the resonance body 2, and may then be distributed on the inner horn-shaped face 18 of the resonance body 2 in a thin layer, and can then be further dispersed on a perforated disc 22, as indicated by the arrows in FIG. 2, where the horn-shaped face may widen into a trumpet-like shape.

The resonance body 2, which may also be excited to generate high-frequency vibrations, can reinforce the vibrations induced in the coating fluid. This may cause concentric capillary waves to be formed in the coating fluid, which is distributed on the horn-shaped face 18. Because of the inertia of the mass of the coating fluid that can be excited to generate capillary waves, very fine droplets of the coating fluid may separate from the vibration curves of the capillary waves, which can lead to the formation of a spray mist.

The resonance body 2 can include the inner horn-shaped face 18 that widens into a trumpet-like shape, as shown in FIG. 2. A transition from a feed line to an atomizing tip and the surface thereof such as that described, e.g., in U.S. Pat. No. 4,655,393, is also shown for comparison purposes in FIG. 2, and is indicated by a dashed line 19 therein. The transition 19 between the feed line and the surface of the atomizing tip has a discontinuity in the form of an edge or corner, which may prevent the coating fluid from being dispersed uniformly on the surface of the atomizing tip. This can then cause coarser drops to become detached from the edge-like transition 19, in an uncontrolled manner, which may result in a reduction in quality of the coating as described above. This reduction in coating quality can be avoided or minimized by using the exemplary atomizing device described herein, which can include the resonance body 2 which has inner horn-shaped face 18, as shown in FIG. 2.

The atomizing arrangement 1 shown in FIG. 1 may be surrounded by a housing 16, which can be open on one side. The resonance body 2 may be arranged proximate to an opening of the housing 16. A nozzle 3, through which air, gas or inert gas may flow, can connect directly to one of the openings of the housing 16 in a form of an expanding funnel, so that an annular gap may be formed between an atomizer plate of the resonance body 2 and the expanding funnel of the nozzle 3. The housing 16, in which the exemplary atomizing arrangement 1 is situated, can be supplied with a controllable inert gas volumetric flow. The flow rate of this gas may be configured or established using a control valve 12, which can be controlled, for example, by a microprocessor 7. The microprocessor 7 can also control, e.g., the operating frequency of the exemplary atomizing arrangement 1 and/or the volumetric flow provided by the precision proportioning pump 4, which can supply the atomizing arrangement 1 with coating fluid from the storage tank 5.

The inert gas, which may be provided to the interior of the housing 16, can be dispersed in the housing 16 and escape from one of the openings of the housing 16 through the annular gap (which may be formed between the atomizer plate of the resonance body 2 and the expanding funnel 3). By using such inert gas which can escape from the housing 16, the spray mist which has separated from the resonance body 2 can be modulated to form various spray patterns. The spray pattern can be varied in different ways, in conjunction with the inert gas nozzle 3 and the inert gas escaping through the annular gap. For example, the volumetric flow of the spray jet can be accelerated by varying the inert gas flow, or the spray jet can be widened or reduced by varying the opening angle of the funnel of the inert gas nozzle 3.

The substrate 14 can be positioned by a substrate holder 8, using a workpiece clamping device 9 that may be associated with the substrate holder 8, beneath the resonance body 2 of the exemplary high frequency atomizing device as shown in FIG. 1. The substrate holder 8 can be configured to controllably move the substrate 14 in three different translational movement directions x, y and z, and one rotational movement direction r shown in FIG. 1. The substrate 14 can therefore be held and moved controllably to a suitable position inside the spray mist using the substrate holder 8 throughout the coating process. The substrate holder 8 may be controlled by the microprocessor 7 which can allow, for example, monitoring of the current position of the substrate 14 and variation of the position of the substrate 14 within the spray mist. The microprocessor 7 can also be used, e.g., to monitor all of the processes and parameters of the spray device.

A controllable vacuum suction system 10 can be provided near the substrate 14, for example, to further condition the spray jet and/or to draw in the overspray. A suction pump that may be included in the controllable vacuum suction system 10 can also controlled by the microprocessor 7.

The exemplary high-frequency atomizing device shown in FIG. 1 can also include a drying arrangement 6 which can include, e.g., a heat source, which may be configured to dry or harden the freshly coated substrate 14. The drying arrangement 6 can include, for example, a heating system that may be controllable by the microprocessor 7, and it may be provided in a housing 20 that can be open on one side. The interior of the housing 20 may be provided with an adjustable inert gas volumetric flow, similar to the housing 16 surrounding the atomizing arrangement 1, where the flow can be regulating using a control valve 13. The control valve 13 may also be controlled by the microprocessor 7 as a function of some or all of the process parameters.

The inert gas volumetric flow fed to the housing 20 can be heated within the housing 20 by heat provided by the heat source 6, and it can escape through an opening in the housing 20 formed by a nozzle 21. The freshly coated substrate 14 can be dried by the heat flow thus generated, but this can require the substrate 14 to be moved from the position shown in FIG. 1 towards the heat source 6. The nozzle 21 of the heat source 6 can also be aligned so that the coating layers freshly applied to the substrate 14 can be dried immediately after their application to the substrate 14, e.g., in the position shown in FIG. 1.

To protect the coating procedure from possible cross flows or dust, the exemplary atomizing arrangement 1, including the housing 16 surrounding it, the drying device 6, the vacuum suction system 10, and the substrate 14 can each be arranged within a housing 11, represented schematically in FIG. 1 by a dashed line. If the drying arrangement 6 is used that includes a source of thermal radiation, it can optionally be arranged outside of the housing 11 and be configured to dry the freshly coated substrate 14 located within the housing 11. It may not be necessary to remove the substrate 14 from the workpiece clamping device 9 of the substrate holder 8 in order to dry the substrate 14 after coating it using the drying arrangement 6. This can avoid possible damage to the coating of the substrate 14 if it is not yet dried when it is removed from the workpiece clamping device 9.

Extensive coating of substrates can be achieved by providing, e.g., a plurality of atomizers arranged in a cascade fashion, and guiding the substrates along the atomizers on a conveying arrangement, or alternatively by guiding the plurality of atomizers along the substrates using a conveying arrangement. Suitable conveying arrangement may include, for example, conveyor belts and the like.

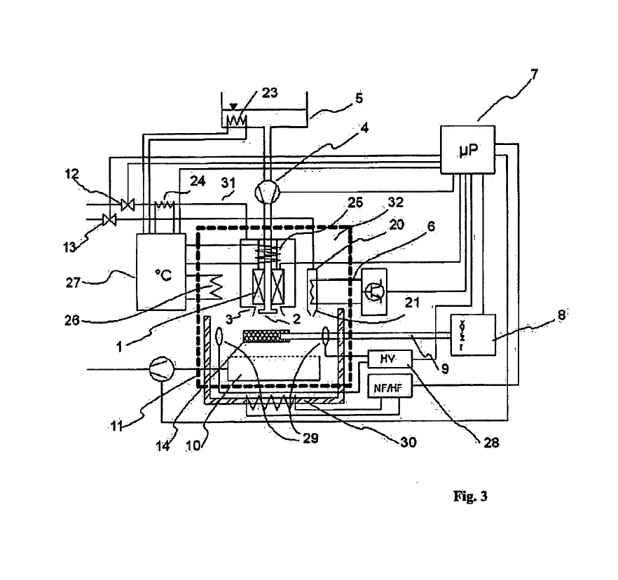

FIG. 3 shows a schematic illustration of another high-frequency atomizing device in accordance with certain exemplary embodiments of the present invention. The exemplary atomizing device shown in FIG. 3 includes a process temperature control arrangement 27 and first temperature setting devices 23, 25, a second temperature setting device 24, and a third temperature setting device 26 connected thereto. The process temperature control arrangement 27 can be connected to the microprocessor 7, and can be configured to receive settings and/or instructions for settings from the microprocessor 7 corresponding to desired process conditions for a coating procedure. For example, temperature gradients of a coating fluid may be produced or compensated for in the storage tank 5 and on the atomizing arrangement 1. Whether a temperature gradient is desired or is to be prevented can depend on the material used as coating fluid and its thermal characteristics. The process temperature control arrangement 27 can allow the behavior of the coating fluid to be influenced during transport or spraying thereof.

The temperature of the coating fluid in the storage tank 5 may be set using the first temperature setting device 23, which is represented schematically in FIG. 1 as a heating coil, as are the other temperature setting devices 24-26. However, these temperature setting devices 23-26 can include other heat sources such as, e.g., infrared radiators, heat exchangers, heat pumps, etc. Moreover, each of the temperature setting devices 23-26 can also be used to extract heat and/or for cooling, and thus may include, e.g., cooling units or fans.

Two first temperature setting devices 23, 25 are shown in FIG. 3 that can be capable of influencing the temperature of the coating fluid. However, any number of such first temperature setting devices may be arranged along the distribution system of the coating fluid as needed or desired. The fluid distribution system includes the storage tank 5, the precision pump 4, the exemplary atomizing arrangement 1 and a tube arrangement which connects the storage tank 5 to the precision pump 4, and the precision pump 4 to the exemplary atomizing arrangement 1. For example, the capillary tube 17 and the resonance body 2 can also be part of the distribution system. Each element of the distribution system can be provided separately with a first temperature setting device. The temperature setting devices 23-26 can, e.g., heat or cool the coating fluid directly. An example of direct heating of the coating fluid in the storage tank 5 by the first temperature setting device 23 is shown, e.g., in FIG. 3.

A temperature setting device (such as the first temperature setting device 25) can indirectly heat or cool the coating fluid by, e.g., heating or cooling a tube between the precision pump 4 and the exemplary atomizing arrangement 1. By varying the temperature of the tube, the temperature of the coating fluid flowing through the tube can be influenced indirectly.

The temperature of the inert gas in an inert gas feed line 31 can be set using the second temperature setting device 24. The tempered inert gas can interact with the spray mist when it is escaping from the inert gas nozzle 3, and may modulate the spray pattern of the spray mist. The temperature of the spray mist which has separated from the resonance body can also be influenced by this interaction between the spray and the inert gas which may be provided at a desired temperature as described above.

The temperature prevailing in the coating chamber 32 can also influence the dispersion behavior and coating behavior of the spray mist on the substrate 14. This prevailing temperature can also determine or influence the behavior of the coating when it is being dried. The thickness of the coating, particularly the coating film, on the substrate 14, can also be influenced by the temperature prevailing in the coating chamber 32.

FIG. 3 also shows an electrical apparatus 29 that is capable of generating an electrical field. The electrical apparatus 29 includes two electrodes which can be connected to a high voltage generator 28. An electrical field can be generated between the electrodes in the region between the exemplary atomizing arrangement 1 and the substrate holder 9 and the substrate 14 by application of a suitable voltage. The substrate 14 and, optionally, at least a portion of the substrate holder 9, may lie within the electrical field, so that the field can act on the spray mist when the sprayed particles adhere to the substrate 14.

FIG. 3 also shows a single-channel structure of the electrical field apparatus 29 that can be configured to generate an electrical field. A multi-channel structure can also be used, where a plurality of apparati 29 may be provided for generating an electrical field, each of which can be separately activated by the high-voltage generator 28.

The high-voltage generator 28 can be connected to the microprocessor 7 and may be controlled thereby. The high-voltage generator 28 can be configured to provide, e.g., electrostatic fields or time-varying electrical fields, which may have an intensity that varies with time or different frequency patterns.

A magnetic field can also be generated, for example, between the atomizing device 1 and the substrate holder 9 using a magnetic field apparatus 30. Such magnetic field apparatus 30 may be magnetostatic, e.g., it can be constant with time or it may vary with time. The modulation of the magnetic field can be produced using a low frequency/high frequency (LF/HF) generator, which can be connected to the microprocessor 7 and which can be configured to receive control signals therefrom. A single-channel structure for the magnetic apparatus 30 is shown in FIG. 3, and a multi-channel apparatus may also be used.

The magnetic field can be generated using, e.g., a permanent magnet or an electromagnet. The magnetic field apparatus 30 shown in FIG. 3 includes an electromagnet. A U-shaped core such as, e.g., a ferrite core, can be surrounded by an electrical coil on an underside of the magnet, where the underside may be the side opposite the resonance body 2. Magnetic field lines can be formed between parallel flanges of the core when excited by a current flow generated by the LF/HF generator in the coil. Magnetic field lines can pass through the space between the flanges. The region between the atomizing arrangement 1 and the substrate 14, and optionally a portion of the substrate holder 9, can also be exposed to the magnetic field. The magnetic field thus may influence the spray mist being directed toward the substrate 14.

Both the electrical field apparatus 29 and the magnetic field apparatus 30, or a portion thereof, may be located either inside housing 11, e.g., within the coating chamber 32, or outside of it. If a suitable material is selected for the housing 11, the electrical and magnetic fields may exert their actions within the housing 11, e.g., from outside into the coating chamber 32. Locating the electric field apparatus 29 and/or the magnetic field apparatus 30 completely outside of the housing 11 may help to prevent or reduce contamination of these components.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. In addition, to the extent that the prior art knowledge has not been explicitly incorporated by reference herein above, it is explicitly being incorporated herein in its entirety. All patents, patent applications and publications referenced herein above are incorporated herein by reference in their entireties.

1-37. (canceled)

38. A high-frequency atomizing device, comprising:
an atomizing arrangement configured to provide a spray mist jet and comprising a horn-shaped resonance body that is excitable to generate high-frequency vibrations;
a housing comprising at least one opening, wherein the particular housing is configured to enclose at least one portion of the atomizing arrangement and wherein the resonance body is provided proximate to the at least one opening;
a nozzle connected to the at least one opening;
a controllable gas supply arrangement configured to provide a flow of a gas to the housing;
a substrate holder arrangement configured to maintain a substrate in a particular position; and
at least one drying arrangement configured to at least one of dry or cure a spray mist coating applied to the substrate.

39. The device of claim 38, wherein the atomizing arrangement is movable relative to the substrate.

40. The device of claim 38, further comprising a storage tank configured to maintain a coating fluid.

41. The device of claim 40, further comprising at least one particular temperature setting arrangement configured to affect a temperature of the coating fluid.

42. The device of claim 41, wherein the at least one particular temperature setting arrangement is configured to be in a thermal communication with the storage tank.

43. The device of claim 41, wherein the at least one particular temperature setting arrangement is configured to be in a thermal communication with the atomizing arrangement.

44. The device of claim 38, further comprising at least one electric field arrangement configured to generate an electrical field in a region between the atomizing arrangement and at least one portion of the substrate holder.

45. The device of claim 38, further comprising at least one magnetic field arrangement configured to generate a magnetic field in a region between the atomizing arrangement and at least one portion of the substrate holder.

46. The device of claim 38, further comprising at least one temperature setting arrangement configured to affect a temperature of the gas.

47. The device of claim 46, wherein the at least one temperature setting arrangement is configured to be in a thermal communication with the controllable gas supply arrangement.

48. The device of claim 38, wherein the nozzle is configured to pass a gas therethrough so as to affect a dispersal of the spray mist jet.

49. The device of claim 38, wherein the substrate holder arrangement is capable of positioning the substrate within the spray mist jet.

50. The device of claim 49, wherein the substrate holder arrangement is capable of moving the substrate using six different degrees of freedom of movement.

51. The device of claim 38, wherein the at least one drying arrangement comprises a heat source.

52. The device of claim 51, wherein the at least one drying arrangement further comprises a heating housing that includes at least one heating opening which is open on one side thereof, and wherein the heating housing is in a communication with the controllable gas supply arrangement, and configured to provide a flow of a heated gas therethrough.

53. The device of claim 51, wherein the heat source comprises an infrared source.

54. The device of claim 38, further comprising a controllable suction arrangement configured to at least one of influence a dispersal of the spray mist jet or withdraw at least one portion of the spray mist jet.

55. The device of claim 54, further comprising at least one further housing that at least partially surrounds at least one of the atomizing arrangement, the substrate holder arrangement, or the controllable suction arrangement.

56. The device of claim 55, wherein the at least one further housing at least partially surrounds the at least one drying arrangement.

57. The device of claim 38, further comprising a processing arrangement configured to control at least one of the atomizing arrangement, the substrate holder arrangement, the controllable gas supply arrangement or the at least one drying arrangement.

58. The device of claim 55, wherein the at least one further housing has a form of a coating chamber, and wherein the atomizing arrangement comprises at least one further temperature setting arrangement configured to affect a temperature of the coating chamber.
